(19) United States
(12) Patent Application Publication
(10) Pub. No.: US 2014/0176712 A1
(43) Pub. Date: Jun. 26, 2014

(54) THERMAL IMAGER FOR A MINE VEHICLE

(71) Applicants: Mark Jerome Redlinger, Lake Ridge, VA (US); Charles Edward Fletcher, Fairfax, VA (US)

(72) Inventors: Mark Jerome Redlinger, Lake Ridge, VA (US); Charles Edward Fletcher, Fairfax, VA (US)

(21) Appl. No.: 13/725,551

(22) Filed: Dec. 21, 2012

(51) Int. Cl. B60R 11/04

(52) U.S. Cl. CPC B60R 11/04
USPC 348/148; 29/592.1

(57) ABSTRACT

An imaging system for enhancing situational awareness during movement of an underground mine vehicle includes a forward viewing camera sensor, such as a thermal camera sensor, that is mounted on the front end of the vehicle. The camera sensor provides a Field of View (FOV) covering a predetermined area in front of the vehicle as the vehicle moves in a forward direction. A second camera sensor can be included to provide a second FOV covering a predetermined area in back of the vehicle as the vehicle moves in a reverse direction. A display monitor is mounted on the vehicle at a vehicle driving station. Transmission lines are provided that extend from each camera sensor to the display monitor. Each camera sensor can include one or more wide angle lenses to establish a relatively wide angle FOV. Typically, the FOV for each camera sensor is about ninety degrees (90°).

### FIELD OF THE INVENTION

The present invention pertains generally to mining equipment. More particularly, the present invention pertains to safety devices for motorized mining equipment to prevent a miner from being hit by a moving piece of mining equipment. The present invention is particularly, but not exclusively, useful as a monitoring device to enhance operator visibility when driving mobile equipment in an underground mining environment.

### BACKGROUND OF THE INVENTION

Underground mining environments present some of the most dangerous workplace conditions. In these environments, miners often work in cramped quarters together with large motorized equipment. Each level in an active mine can include a network of passageways and cross-cuts that miners, often on foot, must share with motorized vehicles. Dust generated by mining activities, together with a lack of direct sunlight, often lead to relatively dark conditions that are accompanied by low visibility.

Under the above-described conditions, working in or near an active haulage travelway can be particularly dangerous. In these cases, large, heavy vehicles, including, for example shuttle cars and scoopers, present a hazard to miners who are working on foot nearby. In addition to light and dust levels, operator visibility can be adversely affected by the material being hauled. In some cases, due to the large amount of material mounded on the mobile equipment, blind spots are created and operators must often stretch to see over or around the material to ensure that their path is clear. Although limits can be placed on the amount of cargo transported in a given run, these limitations can adversely affect productivity and increase mining costs. Reducing vehicle speed, while arguably increasing safety, can also adversely affect productivity and increase mining costs.

Administrative controls mandating communications between operators and miners regarding their positions and movements have also proven insufficient to prevent all accidents between vehicles and miners. In addition to administrative controls, various attempts to increase visibility and reduce accidents have been tried. These attempts have included requiring that equipment provide audible warnings when making turns and reversing directions. Other attempts at accident reduction have included installing visible warning devices at the entrances of an active travelway. In addition, the use of reflective clothing for miners has been implemented. Moreover, in some cases, vehicles and other mobile equipment have been equipped with standard CCTV devices to provide an operator with a forward looking view of the vehicle's path. However, these systems have generally been ineffective due to poor camera resolution in the low visibility conditions. In spite of the practices and procedures described, injuries to miners have continued to occur.

In light of the above, it is an object of the present invention to provide systems and methods for improving safety in a mining environment where vehicles and other mobile equipment are employed. Still another object of the present invention is to improve safety while maintaining operation efficiency in the mining environment. Yet another object of the present invention is to provide a thermal imager for a mine vehicle and corresponding methods of use which are easy to use, relatively simple to implement, and comparatively cost effective.

### SUMMARY OF THE INVENTION

In accordance with the present invention, an imaging system for enhancing situational awareness during movement of an underground mine vehicle system includes a vehicle dimensioned for movement through a mine shaft. For the system, the vehicle has a front end and a rear end and includes a driving station where an on-board operator can control the movements of the vehicle.

For the system, the vehicle can be, for example, a roof bolter, a scooper, a shuttle car or any other type of motorized, operator driven equipment that is designed for use in a mine or other similar environment. In some cases, the vehicle can include a bed that is mounted on the vehicle for carrying a material such as coal, ore, a mineral, an overburden, etc.

To enhance situational awareness during the movement of the vehicle, an imaging system is provided. For the present invention, the imaging system can include a forward viewing camera sensor mounted on the front end of the vehicle to provide a first Field of View (FOV) covering a predetermined area in front of the vehicle as the vehicle moves in a forward direction. Typically, the forward viewing camera sensor is a thermal camera sensor.

The imaging system can also include a display monitor that is mounted on the vehicle at the driving station. A transmission line is provided and extends from the forward viewing camera sensor to the display monitor. Also, for the imaging system, the power for the display and forward viewing camera sensor can be provided by an on-board vehicle power source, e.g. battery.

For the present invention, the forward viewing camera sensor can include an optical system, for example, including one or more wide angle lenses to establish a relatively wide angle FOV for the camera sensor. Typically, a FOV for the forward viewing camera sensor is about ninety Degrees (90°).

In most cases, a backward viewing camera sensor is also included. For this case, the backward viewing camera sensor is mounted on the rear end of the vehicle and provides a second Field of View (FOV) covering a predetermined area to the rear of the vehicle as the vehicle moves in a reverse direction.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a shuttle car (unloaded) for use in a mining operation having an imaging system in accordance with the present invention; and

FIG. 2 is a simplified, top plan view of a layer of a mine including a shuttle car having an imaging system in accordance with the present invention.

### DESCRIPTION OF THE PREFERRED EMBODIMENTS

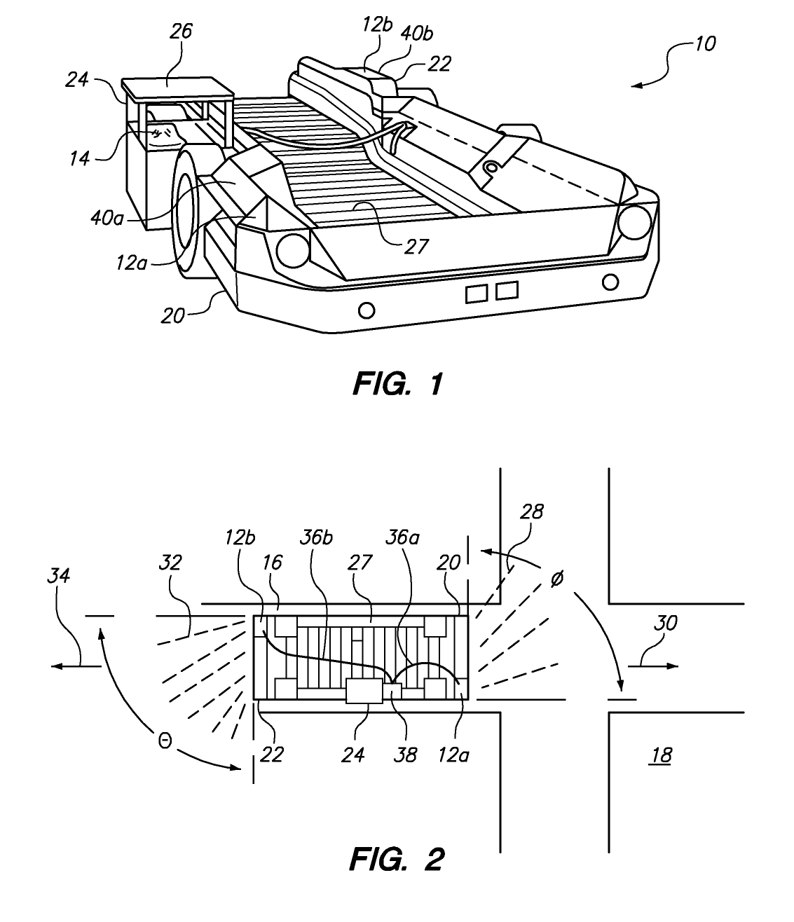

Referring initially to FIG. 1, a vehicle is shown and generally designated 10. For clarity, the description provided herein is with reference to a shuttle car as shown in FIG. 1 with the understanding that the description is equally applicable to a roof bolter, a scooper or any other type of motorized, operator driven equipment that is designed for use in a mine or other similar environment having poor or less than adequate visibility.

Continuing with FIG. 1, it can be seen that the vehicle 10 is equipped with an imaging system that includes thermal camera sensors 12a,b and a display monitor 14. As described herein, the imaging system can be used to enhance situational awareness during movement of the vehicle during mining or other similar operations. In particular, the imaging system is designed to determine whether an individual, such as a miner, is located in the path of the vehicle 10 as the vehicle 10 moves. The imaging system senses the individual's heat, and as a consequence, is able to detect the presence of individuals in dark, low visibility environments.

FIG. 2 shows a vehicle 10 positioned in a passageway 16 of a mine layer 18. As shown, the vehicle 10 is dimensioned for movement through the mine passageway 16.

Cross referencing FIGS. 1 and 2, it can be seen that the vehicle 10 has a front end 20, a rear end 22 and includes a driving station 24 where an on-board operator (not shown) can control the movements (i.e. speed and steering) of the vehicle 10. In more detail, the driving station can include a drivers cupola having a canopy 26. For the vehicle 10 shown, a bed 27 is mounted/formed on the vehicle 10 for carrying a material such as coal, a mineral, an overburden, etc.

FIGS. 1 and 2 show that the imaging system includes a forward viewing thermal camera sensor 12a mounted on the vehicle's front end 20 to provide a Field of View 28 (illustrated by dashed lines) covering a predetermined area in front of the vehicle 10 as the vehicle moves in a forward direction (illustrated by arrow 30). For the vehicle 10, the forward viewing camera sensor 12a can include an optical system, for example, including one or more wide angle lenses or other suitable optics to establish a relatively wide angle FOV, as shown. Typically, the FOV of the sensor 12a subtends an angle, φ, in the range of about 75 degrees to about 105 degrees. In the embodiment shown, the FOV angle, φ, of the forward viewing camera sensor 12a is about ninety degrees (90°). Suitable thermal camera sensors 12a,b for use in the present invention may be obtained from FLIR Systems headquartered in Wilsonville, Oreg.

FIGS. 1 and 2 also show that the imaging system includes a backward viewing thermal camera sensor 12b that is mounted on the vehicle's rear end 22 to provide a Field of View 32 (illustrated by dashed lines) covering a predetermined area behind the vehicle 10 as the vehicle moves in a reverse direction (illustrated by arrow 34). For the vehicle 10, the backward viewing camera sensor 12b can include an optical system, for example, including one or more wide angle lenses or other suitable optics to establish a relatively wide angle FOV, as shown. Typically, the FOV of the sensor 12b subtends an angle, θ, in the range of about 75 degrees to about 105 degrees. In the embodiment shown, the FOV angle, θ, of the backward viewing camera sensor 12b is about ninety degrees (90°).

Referring now to FIG. 1, the imaging system can also include one or more display monitor(s) 14 that are mounted on the vehicle 10 at the driving station 24. For example, two display monitors 14 can be provided, one for the forward viewing camera sensor 12a and one for the backward viewing camera sensor 12b. Alternatively, as shown, a single display monitor 14 may be used for both sensor 12a and sensor 12b. A user operable switch may be provided to change the view on the display monitor 14 from one sensor 12a,b to the other, or, logic may be provided to set the view of the display monitor 12 as a function of vehicle movement (i.e. forward or backward).

As best seen in FIG. 2, a first conduit 36a is provided to establish an electrical connection between the forward viewing camera sensor 12a and the display monitor 14 and a second conduit 36b is provided to establish an electrical connection between the backward viewing camera sensor 12b and the display monitor 14. For the vehicle 10, the conduits 36a,b are intrinsically safe conduits to minimize the risk of fire or explosion. Conduits 36a,b house transmission lines which connect the camera sensor 12a and the display monitor 14 that are typically made of a shielded coaxial cable. In addition, power lines can be positioned in the intrinsically safe conduit 36a,b allowing the camera sensors 12a,b to draw power from an on-board vehicle power source 38 such as a battery. As best seen in FIG. 1, the forward viewing camera sensor 12a, which is typically an explosion proof camera sensor, can be housed within a steel box 40a, as shown, to prevent the risk of fire or explosion in the mining environment. Similarly, backward viewing camera sensor 12b, which also is typically an explosion proof camera sensor, can be housed within a steel box 40b, as shown.

While the particular thermal imager for a mine vehicle as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An imaging system for enhancing situational awareness during movement of an underground mine vehicle which comprises:
a vehicle dimensioned for movement through a mine shaft, wherein the vehicle has a front end and a rear end with a driving station located therebetween;
a bed mounted on the vehicle for carrying a material;
a forward viewing camera sensor mounted on the front end of the vehicle to provide a first Field of View (FOV) covering a predetermined area in front of the vehicle as the vehicle moves in a forward direction;
a backward viewing camera sensor mounted on the rear end of the vehicle to provide a second Field of View (FOV) covering a predetermined area to the rear of the vehicle as the vehicle moves in a reverse direction; and
a display monitor mounted on the vehicle at the driving station for selectively viewing the area in front of the vehicle and the area to the rear of the vehicle during a movement of the vehicle.

2. A system as recited in claim 1 wherein the forward viewing camera sensor and the backward viewing camera sensor are respectively a thermal camera sensor.

3. A system as recited in claim 1 wherein the first FOV and the second FOV are each a ninety degree field (90°).

4. A system as recited in claim 1 wherein the vehicle is selected from the group consisting of a roof bolter, a scooper and a shuttle car.

5. A system as recited in claim 1 wherein the vehicle has an on-board DC power supply and the system further comprises a power line from the forward viewing camera sensor to the power supply, the power line positioned in an intrinsically safe conduit.

6. A system as recited in claim 1 further comprising a transmission line from the forward viewing camera sensor to the display monitor, the transmission line comprising a shielded coaxial cable positioned in an intrinsically safe conduit.

7. A system as recited in claim 1 wherein the forward viewing camera sensor is an explosion proof camera sensor, and said system further comprises a steel box with said forward viewing camera sensor mounted inside said steel box.

8. An imaging system for enhancing situational awareness during movement of an underground mine vehicle which comprises:
a forward viewing thermal camera sensor mountable on an end of the vehicle to provide a Field of View (FOV) covering a predetermined area;
a display monitor mountable on the vehicle at a vehicle driving station for displaying a view of the area in front of the vehicle during a movement of the vehicle; and
a transmission line connecting the thermal camera sensor to the display monitor.

9. A system as recited in claim 8 further comprising a rear viewing thermal camera sensor mountable on an end of the vehicle to provide a rear Field of View (FOV) covering a predetermined area and a second and a second display monitor mountable on the vehicle at the vehicle driving station for displaying a rear view of the area behind the vehicle during a movement of the vehicle; and a second transmission line connecting the rear viewing thermal camera sensor to the second display monitor.

10. A system as recited in claim 8 wherein the FOV subtends an angle, φ, in the range of 75 degrees to 105 degrees.

11. A system as recited in claim 8 wherein the vehicle has an on-board DC power supply and the system further comprises a power line extendable from the camera sensor to the power supply and an intrinsically safe conduit for positioning the power line in.

12. A system as recited in claim 8 wherein the transmission line is a shielded coaxial cable positioned in an intrinsically safe conduit.

13. A system as recited in claim 8 wherein the camera sensor is an explosion proof camera sensor, and said system further comprises a steel box with said camera sensor mounted inside said steel box.

14. A system as recited in claim 8 further comprising a rear viewing thermal camera sensor mountable on an end of the vehicle to provide a rear Field of View (FOV) covering a predetermined area and a second transmission line connecting the rear viewing thermal camera sensor to the display monitor.

15. A method for manufacturing an underground mine vehicle having an imaging system for enhancing situational awareness during vehicle movement comprising the steps of:
providing a vehicle dimensioned for movement through a mine shaft, wherein the vehicle has a front end and a rear end with a driving station located therebetween;
forming a bed on the vehicle for carrying a material;
mounting a forward viewing camera sensor on the front end of the vehicle to provide a first Field of View (FOV) covering a predetermined area in front of the vehicle as the vehicle moves in a forward direction;
mounting a backward viewing camera sensor on the rear end of the vehicle to provide a second Field of View (FOV) covering a predetermined area to the rear of the vehicle as the vehicle moves in a reverse direction; and
attaching a display monitor to the vehicle at the driving station for selectively viewing the area in front of the vehicle and the area to the rear of the vehicle during a movement of the vehicle.

16. A method as recited in claim 15 wherein the forward viewing camera sensor and the backward viewing camera sensor are respectively a thermal camera sensor.

17. A method as recited in claim 15 wherein the first FOV and the second FOV are each a ninety degree field (90°).

18. A method as recited in claim 15 wherein the vehicle is selected from the group consisting of a roof bolter, a scooper and a shuttle car.

19. A method as recited in claim 15 further comprising the step of connecting a power line from the forward viewing camera sensor to an on-board vehicle power supply, the power line positioned in an intrinsically safe conduit.

20. A method as recited in claim 15 further comprising the step of connecting a transmission line from the forward viewing camera sensor to the display monitor, the transmission line comprising a shielded coaxial cable positioned in an intrinsically safe conduit.
